(19) United States
(12) Patent Application Publication
(10) Pub. No.: US 2025/0206099 A1
(43) Pub. Date: Jun. 26, 2025

(54) VEHICULAR AIR CONDITIONING SYSTEM

(71) Applicant: Hanon Systems, Daejeon (KR)

(72) Inventors: Seung Ho Lee, Daejeon (KR); Sang Ki Lee, Daejeon (KR); Dae Keun Park, Daejeon (KR)

(21) Appl. No.: 18/724,741

(22) PCT Filed: Feb. 21, 2023
(86) PCT No.: PCT/KR2023/002424

§ 371 Date: Jun. 27, 2024

(30) Foreign Application Priority Data
Mar. 7, 2022 (KR) 10-2022-0028579
Mar. 7, 2022 (KR) 10-2022-0028583

(51) Int. Cl. B60H 1/00

(52) U.S. Cl. CPC B60H 1/00064; B60H 1/00028; B60H 2001/00107; B60H 2001/002

(57) ABSTRACT

A vehicular air conditioning system includes an air conditioning case with internal flow path introducing air discharged from a blower and feeding the air into a passenger room, a cooling and heating heat exchangers cooling and heating the air flowing along the internal flow path, and a plurality of vents discharging cold and hot air passed through the cooling and heating heat exchanger into the passenger room. The internal flow path is formed in an up-down direction for air flow path to extend in the direction of gravity. The cooling and heating heat exchangers are installed sequentially from the lower to upper side in the direction of gravity to correspond to the air flow path. The vents discharge the cold and the hot air passed through the cooling and heating heat exchanger into the passenger room while distributing cold and hot air in a front-rear direction of a vehicle.

### Technical Field

The present invention relates to a vehicular air conditioning system, and more particularly, a vehicular air conditioning system capable of improving the structure of an air conditioning case and the arrangement of cooling/heating heat exchangers, forming rear vents and rear ducts without increasing the size of the air conditioning case and disposing the rear vents and the rear ducts in a front seat area, and providing a great advantage in securing a space in a front seat area.

### Background Art

Vehicular air conditioning systems are divided into a three-piece type, a semi-center type and a center mounting type depending on the arrangement of a blower and cooling/heating heat exchangers including an evaporator, a heater core, an electric heater, and an indoor condenser.

The semi-center type air conditioning system has a structure in which cooling/heating heat exchangers are installed inside an air conditioning case and a blower is configured separately. The semi-center type air conditioning system is most widely used.

As shown in FIG. 1, the semi-center type air conditioning system (hereinafter referred to as “air conditioning system”) is provided with an air conditioning case 1. A cooling heat exchanger 3, a heating heat exchanger 5 and a temperature control door 7 are installed in an internal flow path la of the air conditioning case 1.

The cooling heat exchanger 3 and the heating heat exchanger 5 are sequentially installed in a substantially vertical state along the air flow path of the internal flow path la, which is formed in a substantially horizontal direction from the engine room side to the passenger room side.

The cooling heat exchanger 3 and the heating heat exchanger 5 installed in this way cool or heat the air blown into the passenger room, thereby supplying cold air or hot air into the passenger room to cool or heat the interior of the passenger room.

The air conditioning case 1 is provided with a defrost vent 1b, a center vent 1c, and a floor vent 1d.

The vents 1b, 1c and 1d discharge the air that has passed through the cooling/heating heat exchangers 3 and 5 to the window glass side in the passenger room, the passenger's face, and the floor side in the passenger room, respectively.

Additionally, the air conditioning case 1 is further provided with a plurality of rear vents 1e.

The rear vents le are formed to face from the portion of the air conditioning case 1 corresponding to the front side of the front seats toward the front seat side in the passenger room, and are connected to rear ducts 8.

The rear vents le connected in this way discharge the air that has passed through the cooling/heating heat exchangers 3 and 5 to the rear seat side in the passenger room.

However, this conventional air conditioning system has many difficulties in securing a space in the passenger room due to the structure of the rear vents le formed to face from the air conditioning case 1 toward the rear seat side.

That is, as shown in FIG. 2, the rear vents le are formed to face from the portion of the air conditioning case 1 on the front of the driver's seat toward the rear seat side. Therefore, the rear vents le protrude toward the front seat side in the passenger room, which makes it difficult to secure a space in the front seat area.

In particular, the rear ducts 8 are connected to the rear vents le. In the process of connecting the rear ducts 8, the rear ducts 8 have to be arranged in the front seat area. This poses a problem that the front seat area becomes narrower.

In consideration of this, the rear vents le may be bent and extended toward the engine room side opposite to the front seat area, thereby minimizing the protrusion of the rear vents le relative to the front seat area and the arrangement of the rear ducts 8.

However, in this case, there is a disadvantage that the size of the air conditioning case 1 has to be increased. This poses a problem that the front seat area becomes narrower.

In particular, recently, for the sake of the passenger convenience and along with the trend of electric vehicles, there exists a demand for the slimming and miniaturization of devices such as a slim cockpit and a flat floor. However, the conventional structure mentioned above is not capable of responding to the demand for the slimming and miniaturization such as a slim cockpit and a flat floor.

In addition, an instrument panel I is installed on the upper side of the air conditioning case 1. During the installation process of the instrument panel I, the instrument panel I may interfere with the rear vents le and the rear ducts 8 assembled to the rear vents le. This poses a problem that the installation work of the instrument panel I is very difficult.

In order to solve this problem, the instrument panel I may be made large to avoid interference with the rear vents le and the rear ducts 8. However, in this case, there is a drawback in that the front seat area becomes narrower.

### SUMMARY

In view of the problems inherent in the related art, it is an object of the present invention to provide a vehicular air conditioning system capable of improving the structure of an air conditioning case and the arrangement of cooling/heating heat exchangers, and forming rear vents and rear ducts without increasing the size of the air conditioning case and disposing the rear vents and the rear ducts in a front seat area.

Another object of the present invention is to provide a vehicular air conditioning system capable of providing a great advantage in securing a space in a front seat area, by forming rear vents and rear ducts without increasing the size of the air conditioning case and disposing the rear vents and the rear ducts in a front seat area.

A further object of the present invention is to provide a vehicular air conditioning system capable of improving passenger convenience and actively responding to a demand for the slimming and miniaturization such as a slim cockpit and a flat floor, by providing a great advantage in securing a space in a front seat area.

A still further object of the present invention is to provide a vehicular air conditioning system capable of allowing an instrument panel to be easily installed without interference with rear vents and rear ducts, by forming the rear vents and the rear ducts without increasing the size of the air conditioning case and disposing the rear vents and the rear ducts in a front seat area.

In order to achieve these objects, there is provided a vehicular air conditioning system, including: an air conditioning case including an internal flow path configured to introduce air discharged from a blower and feed the air into a passenger room, a cooling heat exchanger and a heating heat exchanger configured to cool and heat the air flowing along the internal flow path, and a plurality of vents configured to discharge cold air and hot air passed through the cooling heat exchanger and the heating heat exchanger into the passenger room, wherein the internal flow path of the air conditioning case is formed in an up-down direction so that an air flow path extends from a lower side to an upper side in a direction of gravity, the cooling heat exchanger and the heating heat exchanger on the internal flow path are installed sequentially from the lower side to the upper side in the direction of gravity so as to correspond to the air flow path extending from the lower side to the upper side in the direction of gravity, and the vents are configured to discharge the cold air and the hot air passed through the cooling heat exchanger and the heating heat exchanger into the passenger room while distributing the cold air and the hot air in a front-rear direction of a vehicle.

The internal flow path of the air conditioning case includes an inlet formed on the lowest side in the direction of gravity, a main flow path portion configured to feed the air introduced through the inlet vertically upward, a cold air flow path portion and a hot air flow path portion branched to both sides from the main flow path portion so as to extend vertically upward, and an uppermost air mixing flow path portion where downstream ends of the cold air flow path portion and the hot air flow path portion are merged.

The cooling heat exchanger is installed in the main flow path portion to face from the lower side to the upper side and configured to cool the air flowing from the lower side to the upper side in the direction of gravity along the main flow path portion, and the heating heat exchanger is installed in the hot air flow path portion to face from the lower side to the upper side and configured to heat the air flowing from the lower side to the upper side in the direction of gravity along the hot air flow path portion.

The heating heat exchanger includes a heater core configured to heat the air with cooling water and an electric heater configured to heat the air with electricity, and the heater core and the electric heater are installed sequentially along the hot air flow path portion.

A temperature control door is installed at a branching point of the hot air flow path portion and the cold air flow path portion to adjust opening degrees of the cold air flow path portion and the hot air flow path portion, and the temperature control door is composed of a sliding door and configured to slide between the cold air flow path portion and the hot air flow path portion to adjust the opening degrees of the cold air flow path portion and the hot air flow path portion.

The air conditioning case includes a defrost vent configured to discharge the air in the internal flow path to a window glass in the passenger room, a center vent configured to discharge the air in the internal flow path to a face of a passenger, and a floor vent configured to discharge the air in the internal flow path to a floor in the passenger room, the defrost vent and the center vent are formed in a portion of the air conditioning case corresponding to the air mixing flow path portion of the internal flow path, and the floor vent is formed in a portion of the air conditioning case corresponding to the cold air flow path portion of the internal flow path.

The air conditioning case includes a rear vent configured to discharge the air in the internal flow path to a rear seat area in the passenger room, and the rear vent is formed in a portion of the air conditioning case opposite to the front seat area of the passenger room.

The air conditioning case is installed on the dash panel side in front of the driver's seat, and the rear vent is bent from the air mixing flow path part toward the dash panel in the direction opposite to the front seat area and then extend vertically downward so that the outlet portion thereof faces the floor on the dash panel side in the passenger room.

The system further includes a rear duct connected to the rear vent so that the air discharged from the rear vent can be fed to the rear seat area in the passenger room, wherein the rear duct is connected to the rear vent and arranged to extend from the floor on the dash panel side in the passenger room to the rear seat area through the floor in the front seat area.

According to the vehicular air conditioning system of the present invention, the internal flow path of the air conditioning case is formed in the up-down direction, and the air flow path on the internal flow path side is formed vertically to extend from the lower side to the upper side.

In addition, the cooling/heating heat exchangers on the internal flow path are installed sequentially from the lower side to the upper side so as to correspond to the vertical air flow path extending from the lower side to the upper side.

Therefore, unlike the conventional cooling/heating heat exchangers installed in a substantially vertical state along the horizontal internal flow path, it is possible to significantly reduce the front-rear size of the air conditioning case.

In addition, since the front-rear size of the air conditioning case can be significantly reduced, when the air conditioning case is installed on the dash panel side in the passenger room, it is possible to minimize the protruding length of the air conditioning case from the dash panel side to the front seat area. This provides a great advantage in securing a space in the front seat area.

In particular, since a great advantage is provided in securing a space in the front seat area, it is possible to improve passenger convenience and to actively respond to a demand for the slimming and miniaturization such as a slim cockpit and a flat floor.

In addition, since the protruding length of the air conditioning case relative to the front seat area can be minimized, the instrument panel can be installed in the front seat area of the passenger room without interference with the air conditioning case. This makes it possible to improve the ease of assembling of the instrument panel.

In addition, since the rear vents of the air conditioning case for supplying cold air or hot air to the rear seat area are arranged on the floor area of the passenger room on the dash panel side opposite to the front seat area, unlike the prior art, the rear vents do not protrude into the front seat area of the passenger room. This provides a great advantage in securing a space in the front seat area.

Additionally, since the rear vents are configured to face the floor area of the passenger room on the dash panel side, the rear ducts can be arranged without interfering with the front seat area during the process of connecting the rear ducts to the rear vents.

In addition, since the rear ducts can be arranged without interfering with the front seat area, a great advantage is provided in securing a space in the front seat area. Therefore, it is possible to improve passenger convenience and to actively respond to a demand for the slimming and miniaturization such as a slim cockpit and a flat floor.

In addition, since the rear vents and the rear ducts are arranged without interfering with the front seat area, the instrument panel can be installed on the front seat area in the passenger room without interference with the rear vents and the rear ducts, thereby improving the ease of assembling of the instrument panel.

### BRIEF DESCRIPTION OF THE DRAWINGS

FIG. 1 is a cross-sectional view showing a conventional vehicular air conditioning system.

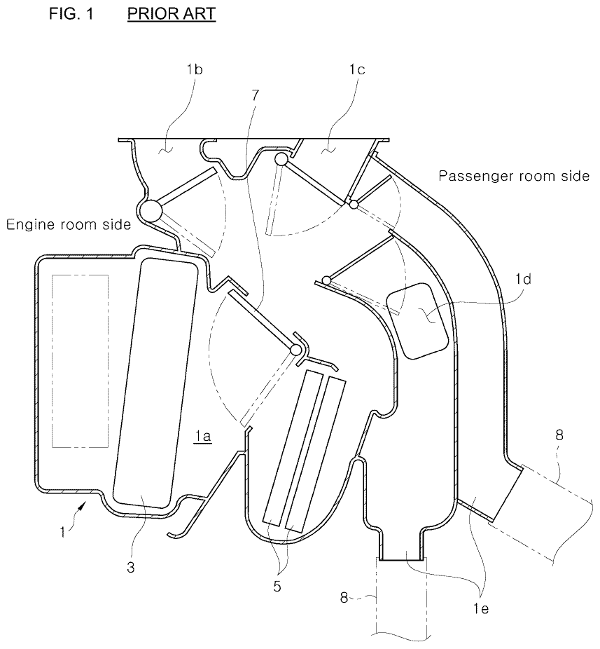

FIG. 2 is a diagram showing the conventional vehicular air conditioning system installed in a vehicle.

FIG. 3 is a cross-sectional view showing a vehicular air conditioning system according to a first embodiment of the present invention.

FIG. 4 is a view showing the vehicular air conditioning system according to the first embodiment of the present invention installed in a vehicle.

FIG. 5 is a diagram showing a vehicular air conditioning system according to a second embodiment of the present invention.

FIG. 6 is a diagram showing a vehicular air conditioning system according to a third embodiment of the present invention.

FIG. 7 is a cross-sectional view taken along line VII-VII in FIG. 6, showing a floor vent, a floor vent partition wall, and a floor vent door constituting the vehicular air conditioning system according to the third embodiment.

FIG. 8 is a diagram showing an operation example of the floor vent partition wall and the floor vent door constituting the vehicular air conditioning system according to the third embodiment.

FIG. 9 is a view showing a modified example of the floor vent partition wall constituting the vehicular air conditioning system according to the third embodiment.

FIG. 10 is a diagram showing a modified example of the floor vent door constituting the vehicular air conditioning system according to the third embodiment.

### DETAILED DESCRIPTION

Preferred embodiments of a vehicular air conditioning system according to the present invention will now be described in detail with reference to the accompanying drawings.

### First Embodiment

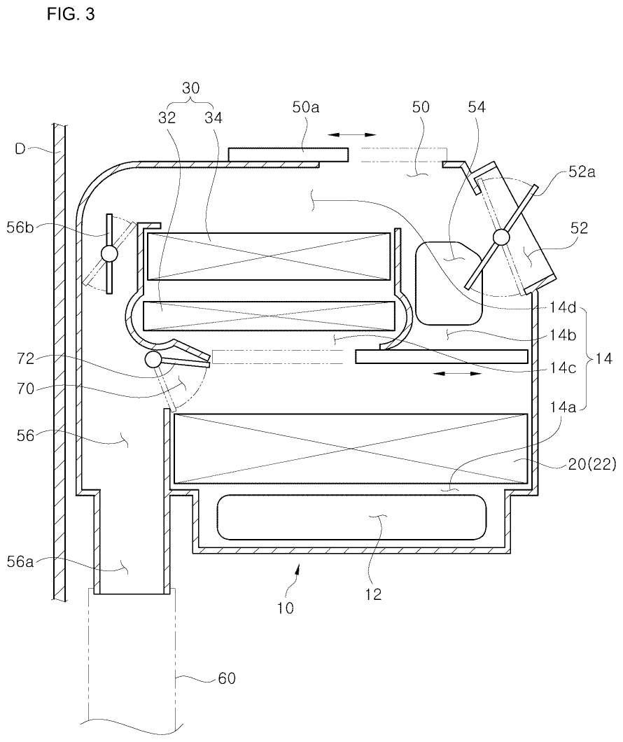

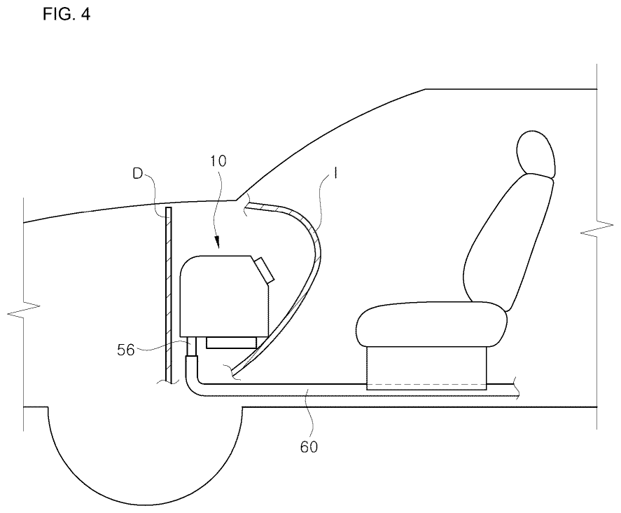

Referring to FIGS. 3 and 4, the air conditioning system of the present invention includes an air conditioning case 10.

The air conditioning case 10 is installed inside an instrument panel I in front of the driver's seat. In particular, the air conditioning case 10 is installed on the dash panel D side of the inner portion of the instrument panel I.

As shown in FIG. 3, this air conditioning case 10 is provided with an inlet 12 through which air discharged from a blower (not shown) can be introduced.

The inlet 12 is formed in the lower portion of the air conditioning case 10 in the direction of gravity. In particular, the inlet 12 is formed in the lowest portion of the air conditioning case 10 in the direction of gravity.

The air conditioning case 10 is provided with an internal flow path 14 that feeds the air introduced through the inlet 12 to the passenger room.

The internal flow path 14 is formed to extend vertically upward from the inlet 12. The internal flow path 14 formed in this way is configured to move the air introduced through the inlet 12 from the lower portion of the air conditioning case 10 toward the upper portion thereof.

Meanwhile, in the internal flow path 14, a cooling heat exchanger 20 and a heating heat exchanger 30 are sequentially installed along the direction of the air flow moving from the lower side toward the upper side in the direction of gravity.

The cooling heat exchanger 20 and the heating heat exchanger 30 are configured to cool and heat the air in the internal flow path 14 fed from the lower side toward the upper side in the direction of gravity.

In more detail, the internal flow path 14 includes a main flow path portion 14a.

In the main flow path portion 14a into which air is introduced from the inlet 12, the cooling heat exchanger 20, i.e., an evaporator 22, is installed.

The cooling heat exchanger 20 is installed in the main flow path portion 14a to face from the lower side toward the upper side in the direction of gravity. The cooling heat exchanger 20 installed in this way is configured to cool the air flowing from the lower side toward the upper side in the direction of gravity along the main flow path portion 14a.

The internal flow path 14 includes a cold air flow path portion 14b and a hot air flow path portion 14c that are branched on both sides from the main flow path portion 14a toward the vertical upper side.

In the hot air flow path portion 14c, the heating heat exchanger 30, for example, a heater core 32, is installed to face from the lower side toward the upper side in the direction of gravity. The temperature control door 40 is installed at the branch point of the hot air flow path portion 14c and the cold air flow path portion 14b.

The cold air flow path portion 14b feeds the cold air cooled by the cooling heat exchanger 20 to the upper portion of the air conditioning case 10, and the hot air flow path portion 14c feeds the hot air heated by the heating heat exchanger 30 to the upper portion of the air conditioning case 10.

The temperature control door 40 moves between the cold air flow path portion 14b and the hot air flow path portion 14c to adjust the opening amounts of the cold air flow path portion 14b and the hot air flow path portion 14c. Therefore, the temperature control door 40 adjusts the amounts of the cold air and the hot air supplied into the passenger room.

In this regard, the temperature control door 40 is configured as a sliding door, and is preferably configured to slide between the cold air flow path portion 14b and the hot air flow path portion 14c to adjust the opening degrees of the cold air flow path portion 14b and the hot air flow path portion 14c. This is to achieve slimming of the air conditioning case 10.

In addition, an electric heater 34, which is the heating heat exchanger 30, is further installed in the hot air flow path portion 14c.

Instead of the heater core 32 that operates by receiving engine coolant, the electric heater 34 heats the air passing through the hot air flow path portion 14c. The electric heater 34 is installed in parallel on the downstream side of the heater core 32.

The cooling heat exchanger 20 and the heating heat exchanger 30 are installed sequentially along the air flow direction from the lower side to the upper side in the direction of gravity, and are preferably arranged so that they overlap at least partially in the up-down direction.

In particular, when the cooling heat exchanger 20 and the heating heat exchanger 30 are arranged to at least partially overlap in an up-down projecting direction when they are projected in the up-down direction.

The reason for adopting this configuration is to achieve sliming of the air conditioning case 10. In particular, this is to reduce the width of the air conditioning case 10 in the front-rear direction.

In this regard, the heating heat exchanger 30 may further include an indoor condenser (not shown) that heats air with a refrigerant.

Referring again to FIG. 3, the cold air flow path portion 14b and the hot air flow path portion 14c of the internal flow path 14 are configured so that the downstream ends thereof are merged into one.

Accordingly, the hot air flowing along the hot air flow path portion 14c and the cold air flowing along the cold air flow path portion 14b can be combined and mixed.

As a result, the hot air and the cold air mixed with each other can be blown into the passenger room through the vents 50, 52, 54 and 56, which will be described later, while maintaining an appropriate temperature. Hereinafter, the merging point of the hot air flow path portion 14c and the cold air flow path portion 14b will be referred to as an air mixing flow path portion 14d.

The air mixing flow path portion 14d is formed at the uppermost portion of the internal flow path 14 of the air conditioning case 10 in the direction of gravity.

Meanwhile, the air conditioning case 10 is provided with a plurality of vents for discharging air from the internal flow path 14 into the passenger room.

The vents include vents that discharge air to the front seat area in the passenger room, for example, a defrost vent 50, a center vent 52, and a floor vent 54.

The defrost vent 50 is used for discharging air from the internal flow path 14 to the window glass in the passenger room, and the opening degree of the defrost vent 50 is adjusted by a defrost door 50a.

The defrost vent 50 is preferably formed in a portion of the air conditioning case 10 corresponding to the air mixing flow path portion 14d on the downstream side of the hot air flow path portion 14c and the cold air flow path portion 14b.

More preferably, the defrost vent 50 is formed in the uppermost portion of the air conditioning case 10 corresponding to the air mixing flow path portion 14d.

In addition, the defrost door 50a is preferably configured as a sliding door, and is configured to side to adjust the opening degree of the defrost vent 50. This is to achieve slimming of the air conditioning case 10.

The center vent 52 is used to discharge the air in the internal flow path 14 toward the face of a passenger, and the opening degree thereof is adjusted by a vent door 52a.

The center vent 52 is preferably formed in a portion of the air conditioning case 10 corresponding to the air mixing flow path portion 14d on the downstream side of the hot air flow path portion 14c and the cold air flow path portion 14b.

In this regard, the center vent 52 is preferably formed in a portion of the air conditioning case 10 corresponding to the air mixing flow path portion 14d at a position lower than the defrost vent 50.

In some cases, the center vent 52 may be formed in a portion of the air conditioning case 10 at the same height as the defrost vent 50.

In addition, the center vent 52 may be formed in a portion of the air conditioning case 10 corresponding to the air mixing flow path portion 14d at a position closer to the cold air flow path portion 14b than the hot air flow path.

In some cases, the center vent 52 may be formed in a portion of the air conditioning case 10 corresponding to the cold air flow path portion 14b.

In addition, the vent door 52a is preferably configured as a flat door, and is configured to rotate to adjust the opening degree of the center vent 52.

In some cases, the vent door 52a may be configured as a sliding door.

The floor vent 54 is used for discharging air from the internal flow path 14 to the floor in the passenger room, and is formed in a portion of the air conditioning case 10 corresponding to the cold air flow path portion 14b.

The floor vent 54 formed in this way is mainly configured to discharge air in the cold air flow path portion 14b to the floor in the passenger room.

In this regard, when the cold air flow path portion 14b is blocked by the temperature control door 40, the hot air in the hot air flow path portion 14c is discharged to the floor in the passenger room.

Meanwhile, the defrost vent 50, the center vent 52, and the floor vent 54 are preferably formed in the air conditioning case 10 to face the seats in the passenger room. In particular, the defrost vent 50, the center vent 52, and the floor vent 54 are preferably formed to face the rear seat in the passenger room.

Referring again to FIG. 3, the air conditioning case 10 further includes a rear vent 56 for discharging air from the internal flow path 14 to the rear seat area in the passenger room.

The rear vent 56 is bent at an angle of about 90° from the air mixing flow path portion 14d on the downstream side of the hot air flow path portion 14c and the cold air flow path portion 14b toward the dash panel D opposite to the front seat area, and then extends vertically downward at an angle of about 90°.

Ultimately, the outlet portion 56a thereof faces the floor in the passenger room on the dash panel D side.

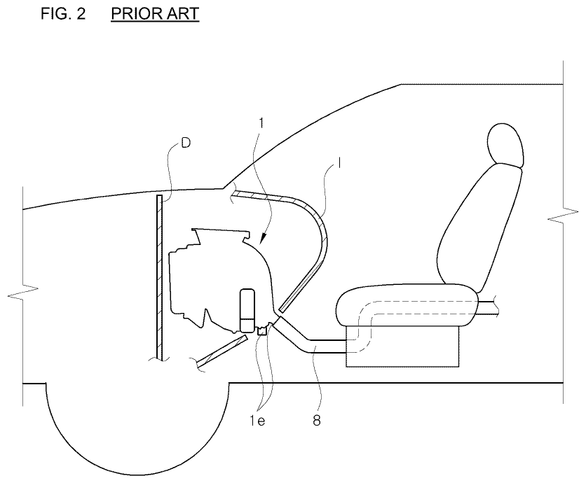

As shown in FIGS. 3 and 4, the rear vent 56 of this structure is configured to face the floor in the passenger room on the side of the dash panel D opposite to the front seat area. Therefore, unlike the prior art (see FIG. 2), the rear vent 56 does not protrude toward the front seat area in the passenger room. This provides a great advantage in securing a space in the front seat area.

In particular, since the rear vent 56 is configured to face the floor in the passenger room on the dash panel D side, in the process of connecting the rear duct 60 to the rear vent 56, the rear duct 60 can be arranged regardless of the front seat area.

That is, the rear duct 60 is connected to the rear vent 56 facing the floor in the passenger room on the dash panel D side, and then arranged to extend from the floor in the passenger room on the dash panel D side to the floor in the front seat area. The rear duct 60 arranged in this way, does not interfere with the front seat area.

Therefore, a great advantage is provided in securing a space in the front seat area. This makes it possible to improve passenger convenience and to actively respond to a demand for the slimming and miniaturization such as a slim cockpit and a flat floor.

In addition, since the rear vent 56 and the rear duct 60 are arranged without interference with the front seat area, the instrument panel I can be installed in the front seat area in the passenger room without interference with the rear vent 56 and the rear duct 60. This makes it possible to improve the ease of assembling of the instrument panel I.

Furthermore, the rear vent 56 facing the dash panel D is disposed on the front side of the vehicle.

Unlike the defrost vent 50, the center vent 52 and the floor vent 54 installed to face the rear seats in the passenger room, the rear vent 56 arranged in this way discharges the cold air or the hot air heat-exchanged in the cooling heat exchanger 20 or the heating heat exchanger 30 toward the front side in the passenger room of the vehicle.

In particular, the defrost vent 50, the center vent 52 and the floor vent 54 discharge the cold air or the hot air heat-exchanged in the cooling heat exchanger 20 or the heating heat exchanger 30 toward the rear side in the passenger room of the vehicle, while the rear vent 56 discharges the cold air or the hot air heat-exchanged in the cooling heat exchanger 20 or the heating heat exchanger 30 toward the front side in the passenger room of the vehicle.

In other words, the defrost vent 50, the center vent 52, the floor vent 54 and the rear vent 56 are configured to distribute the cold or the hot air from the cooling heat exchanger 20 or the heating heat exchanger 30 toward the front and rear sides in the passenger room of the vehicle.

Referring again to FIG. 3, a rear vent door 56b is installed on the rear vent 56.

The rear vent door 56b is configured to adjust the opening degree of the rear vent 56, thereby controlling the amount of the cold or the hot air blown to the rear seat area.

In this regard, the rear vent door 56b is preferably configured as a flat door, and is configured to rotate to adjust the opening degree of the rear vent 56.

Meanwhile, the air conditioning case 10 further includes a rear cold air flow path 70 that directly connects the main flow path portion on the downstream side of the cooling heat exchanger 20 and the rear vent 56, and a rear temperature control door 72 configured to adjust an opening degree of the rear cold air flow path 70.

The rear cold air flow path 70 directly sends a part of the cold air that has passed through the cooling heat exchanger 20 to the rear vent 56. In particular, a part of the cold air that has passed through the cooling heat exchanger 20 is directly sent to the rear vent 56 without passing through the heating heat exchanger 30.

Accordingly, the cold air on the side of the cooling heat exchanger 20 is prevented from unnecessarily passing through the heating heat exchanger 30.

Therefore, the flow resistance due to unnecessary flow path of the cold air through the heating heat exchanger 30 can be minimized. As a result, the noise caused by the flow resistance and the decrease in the amount of air blown to the rear seat can be minimized.

The rear temperature control door 72 is installed on the rear cold air flow path 70 to open and close the rear cold air flow path 70.

It is desirable that the rear temperature control door 72 is configured as a flat door and configured to rotate to adjust the opening degree of the rear cold air flow path 70.

### Second Embodiment

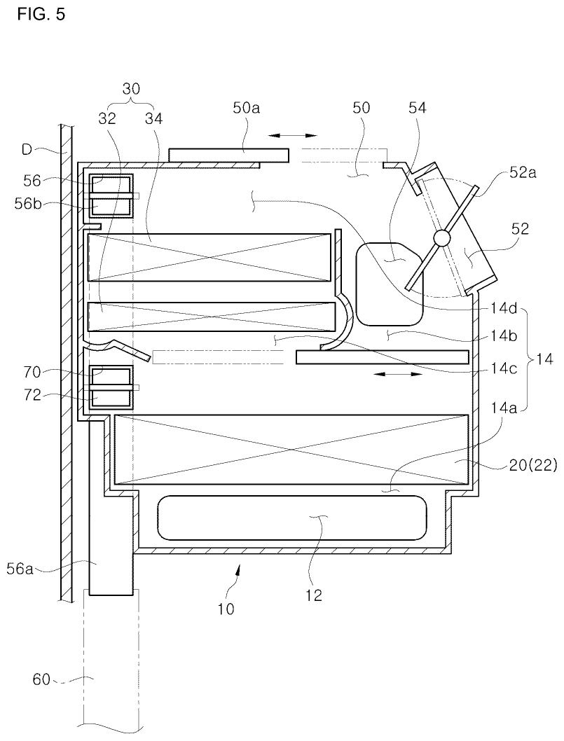

Next, a vehicular air conditioning system according to a second embodiment of the present invention will be described with reference to FIG. 5.

The vehicular air conditioning system of the second embodiment has substantially the same structure as that of the first embodiment described above.

In the first embodiment, the rear vent 56 is formed on the rear surface of the air conditioning case 10 corresponding to the dash panel D. However, in the second embodiment, the rear vent 56 is formed on one side or both sides of the air conditioning case 10 corresponding to the dash panel D.

In particular, the rear vent 56 is bent at an angle of about 90° from the air mixing flow path portion 14d toward the dash panel D, and then extends vertically downward at an angle of about 90° from one side surface or both side surfaces of the air conditioning case 10 corresponding to the dash panel D.

Ultimately, the outlet portion 56a thereof faces the floor in the passenger room on the dash panel D side.

Meanwhile, in the second embodiment, the rear cold air flow path 70 and the rear temperature control door 72 are installed. In some cases, the rear cold air flow path 70 and the rear temperature control door 72 may be omitted.

In the case where the rear cold air flow path 70 and the rear temperature control door 72 do not exist, the rear vent 56 discharges the air from the heating heat exchanger 30 only to the floor in the rear seat area of the passenger room.

When the rear cold air flow path 70 and the rear temperature control door 72 are installed, the rear vent 56 discharges the hot air on the heating heat exchanger 30 side to the floor in the rear seat area of the passenger room, or discharges the cold air on the cooling heat exchanger 20 side in the rear cold air flow path 70 to the console vent side in the rear seat area.

### Third Embodiment

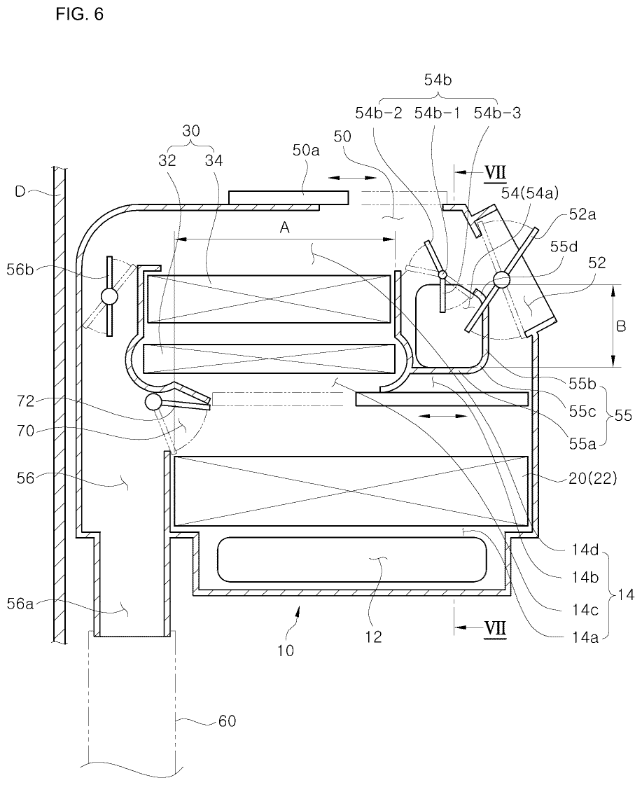

Next, a vehicular air conditioning system according to a third embodiment of the present invention will be described with reference to FIGS. 6 to 10.

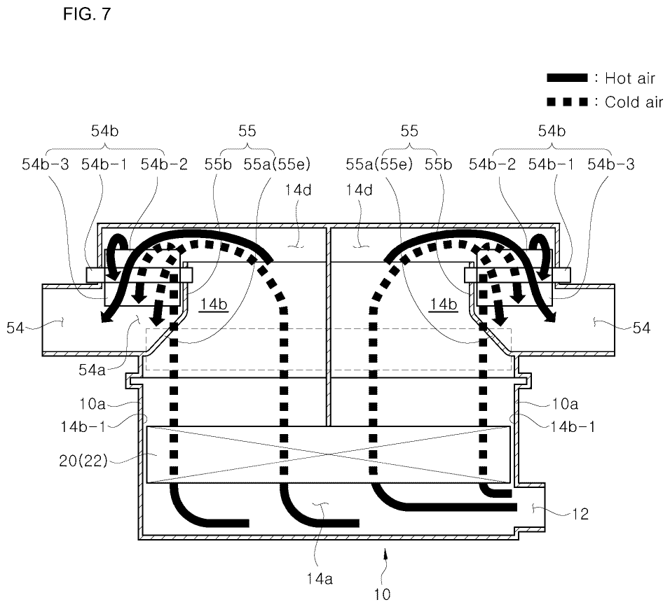

Referring to FIGS. 6 and 7, the vehicular air conditioning system of the third embodiment has substantially the same structure as that of the first embodiment described above.

However, in the third embodiment, the structure on the floor vent 54 side is different from the structure on the floor vent 54 side in the first embodiment described above.

Specifically, the floor vent 54 of the third embodiment is formed on both side surfaces 10a of the air conditioning case 10.

In particular, the floor vent 54 is formed on both side surfaces 10a of the air conditioning case 10, which correspond to the cold air flow path portion 14b.

The floor vent 54 formed in this way discharges the air in the internal flow path 14 to both sides of the air conditioning case 10 and finally discharges the air to the floor in the passenger room.

In this regard, the floor vent 54 is preferably formed at a height corresponding to the height of the heating heat exchanger 30.

More preferably, the floor vent 54 is formed at a position where the floor vent 54 at least partially overlaps with the heating heat exchanger 30 in the front-rear direction of the vehicle.

In particular, when the floor vent 54 and the heating heat exchanger 30 are arranged so that when they are projected in the front-rear direction of the vehicle, at least portions of the floor vent 54 and the heating heat exchanger 30 overlap with each other in the front-rear projection direction (B).

The reason for adopting this configuration is to achieve the sliming of the air conditioning case 10, particularly to reduce the height of the air conditioning case 10 in the up-down direction.

Meanwhile, on the periphery of the inlet 54a of the floor vent 54, a partition wall 55 is formed to partially block the communication between the cold air flow path portion 14b and the inlet 54a of the floor vent 54.

The partition wall 55 is formed in a three-dimensional shape on the periphery of the inlet 54a of the floor vent 54. The partition wall 55 includes a first partition wall portion 55a disposed between the floor vent 54 and the cooling heat exchanger 20, and a second partition wall portion 55b extending from the distal end of the first partition wall portion 55a toward the air mixing flow path portion 14d along the circumference of the floor vent 54.

Since the first partition wall portion 55a is disposed between the floor vent 54 and the cooling heat exchanger 20, the cold air blown from the cooling heat exchanger 20 is prevented from flowing directly into the floor vent 54.

The second partition wall portion 55b isolates a portion of the floor vent 54 excluding the portion thereof on the downstream side of the cold air flow path portion 14b from the cold air flow path portion 14b, and prevents the cold air fed along the cold air flow path portion 14b from flowing directly into the floor vent 54.

In this regard, the second partition wall portion 55b is formed to extend toward the air mixing flow path portion 14d while isolating the floor vent 54 and the cold air flow path portion 14b.

The second partition wall portion 55b guides the cold air flowing along the cold air flow path portion 14b toward the air mixing flow path portion 14d, and makes sure that the inlet 54a of the floor vent 54 corresponds to the air mixing flow path portion 14d side.

In particular, the inlet 54a of the floor vent 54 is extended so as to be open toward the air mixing flow path portion 14d.

As shown in FIGS. 6 to 8, the first and second partition wall portions 55a and 55b configured in this way serve to prevent the cold air that flows forward from the cooling heat exchanger 20 along the cold air flow path portion 14b from flowing into the floor vent 54.

The first and second partition walls 55a and 55b allow a mixture of the cold air moved to the downstream side of the cold air flow path portion 14b and the hot air on the side of the air mixing flow path portion 14d to flow into the floor vent 54.

Accordingly, the hot air and the cold air in the air mixing flow path portion 14d can be introduced simultaneously into the inlet 54a of the floor vent 54. As a result, a mixture of the hot air and the cold air can be discharged to the floor in the passenger room while maintaining an appropriate temperature.

Meanwhile, the first and second partition wall portions 55a and 55b are formed around the inlet 54a of the floor vent 54 in the cold air flow path portion 14b so as to minimize the flow resistance for the air flowing along the cold air flow path portion 14b.

For example, the connecting portion 55c of the first and second partition wall portions 55a and 55b and the specific bent portion 55d bent at a certain angle have a curved surface structure. Therefore, the resistance to the air on the cold air flow path portion 14b is minimized.

Further, the portion 55e of the first and second partition wall portions 55a and 55b corresponding to the air flow on the cold air flow path portion 14b side is configured to be tapered at a specific angle. Therefore, the resistance to the air on the cold air flow path portion 14b is minimized.

In addition, it is preferable that the height of the first and second partition wall portions 55a and 55b is equal to or lower than the height of the heating heat exchanger 30 in the up-down direction of the air conditioning case 10.

The reason for adopting this configuration is to minimize the loss of the cold air and the hot air flowing into the inlet 54a of the floor vent 54.

Referring again to FIGS. 6 and 7, a floor vent door 54b is installed at the inlet 54a of the floor vent 54.

The floor vent door 54b is composed of a flat door, and is configured to rotate to adjust the opening degree of the floor vent 54.

In this regard, the floor vent door 54b includes a rotation center shaft 54b-1, a first flat door portion 54b-2 extending to one side from the rotation center shaft 54b-1, and a second flat door portion 54b-3 extending to the other side from the rotation center shaft 54b-1.

The floor vent door 54b configured in this way is preferably installed in a portion of the inlet 54a side of the floor vent 54 that is opened toward the air mixing flow path portion 14d by the partition wall 55.

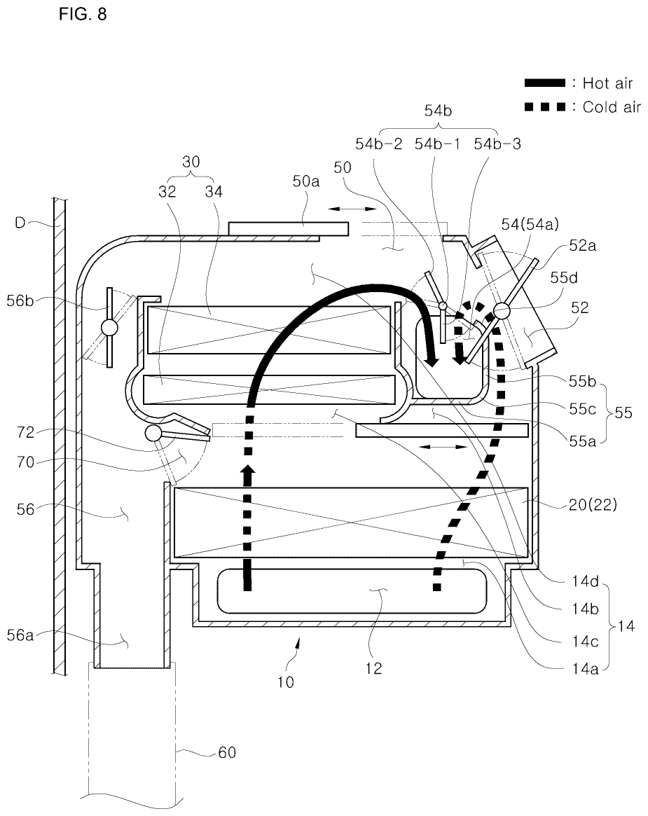

In particular, as shown in FIGS. 6 and 8, the first flat door portion 54b-2 and the second flat door portion 54b-3 are installed so as to correspond to the downstream sides of the air mixing flow path portion 14d and the cold air flow path portion 14b, respectively.

The first flat door portion 54b-2 and the second flat door portion 54b-3 installed in this way serves to guide the hot air in the air mixing flow path portion 14d and the cold air on the downstream side of the cold air flow path portion 14b to the floor vent 54 when the inlet 54a of the floor vent 54 is opened.

Referring again to FIGS. 6 and 7, the partition wall 55 is formed around the inlet 54a of the floor vent 54 in the cold air flow path portion 14b, and is formed between the floor vent 54 and the center vent 52.

In addition, the partition wall 55 is formed around the inlet 54a of the floor vent 54 on both sides in the cold air flow path portion 14b, and as shown in FIG. 7, the partition wall 55 is configured to protrude three-dimensionally inward from the inner wall surface 14b-1 of the cold air flow path portion 14b.

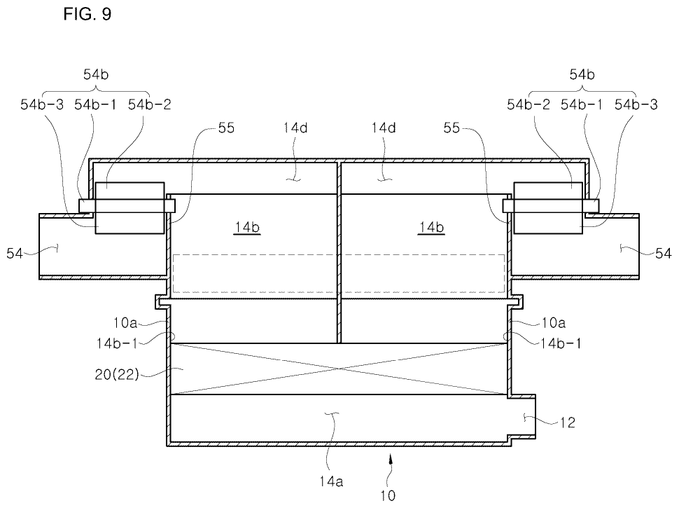

In some cases, as shown in FIG. 9, the partition wall 55 is formed around the inlet 54a of the floor vent 54 in the cold air flow path portion 14b, and may be formed on the same plane as the inner wall surfaces 14b-1 of the cold air flow path portion 14b.

In this case, since the partition wall 55 does not protrude from both inner wall surfaces 14b-1 of the cold air flow path portion 14b, it does not generate resistance to the air blown along the cold air flow path portion 14b.

Meanwhile, when the partition wall 55 is formed on the same plane as the inner wall surfaces 14b-1 of the cold air flow path portion 14b, the inlet 54a of the floor vent 54 corresponding to the partition wall 55 may be narrow, and thus, the installation space of the floor vent door 54b may be reduced.

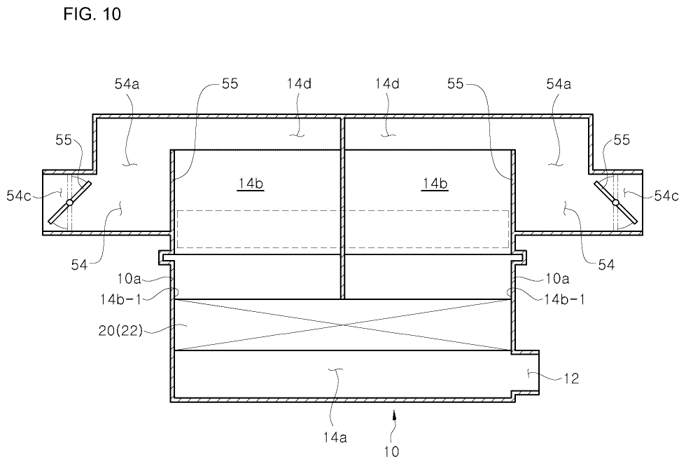

In this case, as shown in FIG. 10, the floor vent door 54b is preferably installed on the side of the outlet 54c of the floor vent 54.

According to the vehicular air conditioning system of the present invention configured as above, the internal flow path 14 of the air conditioning case 10 is formed in the up-down direction, and the air flow path on the internal flow path 14 side is formed vertically to extend from the lower side to the upper side.

In addition, the cooling/heating heat exchangers 20 and 30 on the internal flow path 14 are installed sequentially from the lower side to the upper side so as to correspond to the vertical air flow path extending from the lower side to the upper side.

Therefore, unlike the conventional cooling/heating heat exchangers 20 and 30 installed in a substantially vertical state along the horizontal internal flow path 14, it is possible to significantly reduce the size of the air conditioning case 10. Particularly, it is possible to significantly reduce the front-rear size of the air conditioning case 10.

Thus, when the air conditioning case 10 is installed on the dash panel D side in the passenger room, it is possible to minimize the protruding length of the air conditioning case 10 from the dash panel D side to the front seat area. This provides a great advantage in securing a space in the front seat area.

In particular, since a great advantage is provided in securing a space in the front seat area, it is possible to improve passenger convenience and to actively respond to a demand for the slimming and miniaturization such as a slim cockpit and a flat floor.

In addition, since the protruding length of the air conditioning case 10 relative to the front seat area can be minimized, the instrument panel I can be installed in the front seat area of the passenger room without interference with the air conditioning case 10. This makes it possible to improve the ease of assembling of the instrument panel I.

In addition, since the rear vents 56 of the air conditioning case 10 for supplying cold air or hot air to the rear seat area are arranged on the floor area of the passenger room on the dash panel D side opposite to the front seat area, unlike the prior art, the rear vents 56 do not protrude into the front seat area of the passenger room. This provides a great advantage in securing a space in the front seat area.

Additionally, since the rear vents 56 are configured to face the floor area of the passenger room on the dash panel D side, the rear ducts 60 can be arranged without interfering with the front seat area during the process of connecting the rear ducts 60 to the rear vents 56.

In addition, since the rear ducts 60 can be arranged without interfering with the front seat area, a great advantage is provided in securing a space in the front seat area. Therefore, it is possible to improve passenger convenience and to actively respond to a demand for the slimming and miniaturization such as a slim cockpit and a flat floor.

In addition, since the rear vents 56 and the rear ducts 60 are arranged without interfering with the front seat area, the instrument panel I can be installed on the front seat area in the passenger room without interference with the rear vents 56 and the rear ducts 60, thereby improving the ease of assembling of the instrument panel I.

While the preferred embodiments of the present invention have been described above, the present invention is not limited to the above-described embodiments. Various modifications and changes may be made without departing from the scope and spirit of the present invention defined in the claims.

1. A vehicular air conditioning system, comprising:
an air conditioning case including an internal flow path configured to introduce air discharged from a blower and feed the air into a passenger room, a cooling heat exchanger and a heating heat exchanger configured to cool and heat the air flowing along the internal flow path, and a plurality of vents configured to discharge cold air and hot air passed through the cooling heat exchanger and the heating heat exchanger into the passenger room,
wherein the internal flow path of the air conditioning case is formed in an up-down direction so that an air flow path extends from a lower side to an upper side in a direction of gravity, the cooling heat exchanger and the heating heat exchanger on the internal flow path are installed sequentially from the lower side to the upper side in the direction of gravity so as to correspond to the air flow path extending from the lower side to the upper side in the direction of gravity, and
the vents are configured to discharge the cold air and the hot air passed through the cooling heat exchanger and the heating heat exchanger into the passenger room while distributing the cold air and the hot air in a front-rear direction of a vehicle.

2. The system of claim 1, wherein the internal flow path of the air conditioning case includes an inlet formed on the lowest side in the direction of gravity, a main flow path portion configured to feed the air introduced through the inlet vertically upward, a cold air flow path portion and a hot air flow path portion branched to both sides from the main flow path portion so as to extend vertically upward, and an uppermost air mixing flow path portion where downstream ends of the cold air flow path portion and the hot air flow path portion are merged.

3. The system of claim 2, wherein the cooling heat exchanger is installed in the main flow path portion to face from the lower side to the upper side and configured to cool the air flowing from the lower side to the upper side in the direction of gravity along the main flow path portion, and the heating heat exchanger is installed in the hot air flow path portion to face from the lower side to the upper side and configured to heat the air flowing from the lower side to the upper side in the direction of gravity along the hot air flow path portion.

4. The system of claim 3, wherein the heating heat exchanger includes at least one of an indoor condenser configured to heat the air with a refrigerant, a heater core configured to heat the air with cooling water, and an electric heater configured to heat the air with electricity.

5. The system of claim 4, wherein the cooling heat exchanger and the heating heat exchanger are installed sequentially along air flow direction from the lower side to the upper side in the direction of gravity, and are arranged so as to at least partially overlap with each other in the up-down direction.

6. The system of claim 3, wherein a temperature control door is installed at a branching point of the hot air flow path portion and the cold air flow path portion to adjust opening degrees of the cold air flow path portion and the hot air flow path portion, and the temperature control door is composed of a sliding door and configured to slide between the cold air flow path portion and the hot air flow path portion to adjust the opening degrees of the cold air flow path portion and the hot air flow path portion.

7. The system of claim 6, wherein the air conditioning case includes a defrost vent configured to discharge the air in the internal flow path to a window glass in the passenger room, a center vent configured to discharge the air in the internal flow path to a face of a passenger, and a floor vent configured to discharge the air in the internal flow path to a floor in the passenger room,
the defrost vent and the center vent are formed in a portion of the air conditioning case corresponding to the air mixing flow path portion of the internal flow path, and
the floor vent is formed in a portion of the air conditioning case corresponding to the cold air flow path portion of the internal flow path.

8. The system of claim 7, wherein the defrost vent is formed in a portion of the air conditioning case corresponding to the air mixing flow path portion on the uppermost side in the direction of gravity.

9. The system of claim 8, wherein the center vent is formed in a portion of the air conditioning case corresponding to the air mixing flow path portion at a lower height than the defrost vent.

10. The system of claim 8, wherein the center vent is formed in a portion of the air conditioning case corresponding to the air mixing flow path portion at the same height as the defrost vent.

11. The system of claim 8, wherein the center vent is formed in a portion of the air conditioning case corresponding to the air mixing flow path portion at a position closer to the cold air flow path portion than the hot air flow path portion.

12. The system of claim 7, further comprising:
a defrost door configured to adjust an opening degree of the defrost vent; and
a vent door configured to adjust an opening degree of the center vent,
wherein the defrost door is a sliding door and configured to slide to adjust the opening degree of the defrost vent, and
the vent door is a flat door and configured to rotate to adjust the opening degree of the center vent.

13. The system of claim 1, wherein the air conditioning case includes a front seat vent configured to discharge the air to a front seat area, and a rear vent configured to discharge the air to a rear seat area, and
the rear vent is arranged closer to a dash panel than the front seat vent.

14. The system of claim 13, wherein the front seat vent includes the defrost vent, the center vent and the floor vent,
the defrost vent, the center vent and the floor vent are formed in a portion of the air conditioning case on the seat side in the passenger room to discharge the cold or the hot air from the cooling heat exchanger or the heating heat exchanger toward the passenger room on the rear side of the vehicle, and
the rear vent is formed in a portion of the air conditioning case on the dash panel side to discharge the cold or the hot air from the cooling heat exchanger or the heating heat exchanger toward the passenger room on the front side of the vehicle.

15. The system of claim 14, wherein the rear vent is formed on a rear surface portion of the air conditioning case corresponding to the dash panel.

16. The system of claim 15, wherein the rear vent has an air flow path bent from the air mixing flow path portion toward the dash panel so that an outlet portion thereof faces the floor of the passenger room.

17. The system of claim 14, wherein the rear vent is formed on one side surface or both side surfaces of the air conditioning case corresponding to the dash panel.

18. The system of claim 17, wherein the rear vent has an air flow path bent from the air mixing flow path portion toward the dash panel so that an outlet portion thereof faces from one side surface or both side surfaces of the air conditioning case to the floor of the passenger room.

19. The system of claim 18, further comprising:
a rear duct connected to the rear vent so that the air discharged from the rear vent can be fed to the rear seat area in the passenger room,
wherein the rear duct is connected to the rear vent and arranged to extend from a floor on the dash panel side in the passenger room to a rear seat area through a floor in a front seat area.

20. The system of claim 19, further comprising:
a rear vent door configured to adjust an opening degree of the rear vent.

21. The system of claim 20, further comprising:
a rear cold air flow path configured to bring a main flow path portion on the downstream side of the cooling heat exchanger with direct communication with the rear vent to feed a part of the cold air passed through the cooling heat exchanger toward the rear vent; and
a rear temperature control door configured to adjust an opening degree of the rear cold air flow path.

22. The system of claim 7, wherein the floor vent is formed at a position where the floor vent at least partially overlaps with the heating heat exchanger.

23. The system of claim 22, wherein floor vents are formed on both side surfaces of the air conditioning case to discharge the air in the internal flow path from both sides of the air conditioning case to the floor in the passenger room, and
a partition wall is formed in each of inlets of the floor vents to partially prevent communication between the cold air flow path portion and the inlets of the floor vents.

24. The system of claim 23, wherein the partition wall is configured to guide the cold air flowing along the cold air flow path toward the air mixing flow path.

25. The system of claim 24, wherein the partition wall is configured to minimize flow resistance of the air fed along the cold air flow path portion.

26. The system of claim 25, wherein the partition wall is formed around each of the inlets of the floor vents and configured to three-dimensionally protrude inward from the inner wall surfaces of the air conditioning case on both sides of the internal flow path.

27. The system of claim 26, wherein the partition wall includes a three-dimensional bent portion having a curved structure to minimize resistance to the air in the cold air flow path portion, and a three-dimensional portion corresponding to the air flow on the cold air flow path portion and having a shape tapered at a specific angle to minimize resistance to the air on the cold air flow path portion side.

28. The system of claim 27, wherein the partition wall is formed to have a height equal to or smaller than the height of the heating heat exchanger.

29. The system of claim 25, wherein the partition wall is formed around each of the inlets of the floor vents, and is formed on the same plane as the inner wall surfaces of the air conditioning case on both sides of the internal flow path.

30. The system of claim 23, further comprising:
a floor vent door configured to adjust an opening degree of the floor vent.

31. The system of claim 30, wherein the floor vent door is a flat door installed on the inlets of the floor vents, and includes a central rotation center shaft and a first flat door portion and a second flat door portion extending to both sides from the rotation center shaft to directly control the opening degree of the floor vents.

32. The system of claim 31, wherein the first flat door portion corresponds to the air mixing flow path portion,
the second flat door portion corresponds to the downstream side of the cold air flow path portion, and
the first flat door portion and the second flat door portion are configured to guide the air in the air mixing flow path portion and the air on the downstream side of the cold air flow path portion toward the floor vent when the floor vent is opened.
